(19) United States
(12) Patent Application Publication
(10) Pub. No.: US 2023/0291638 A1
(43) Pub. Date: Sep. 14, 2023

(54) Zero-Touch Provisioning of an Access Point by a Switch

(71) Applicant: ARRIS Enterprises LLC, Suwanee, GA (US)

(72) Inventors: Saravanan Mohandass, Bangalore (IN); SivaLingaPrasad Sola, Bangalore (IN)

(73) Assignee: ARRIS Enterprises LLC, Suwanee, GA (US)

(21) Appl. No.: 18/118,270

(22) Filed: Mar. 7, 2023

Related U.S. Application Data
(60) Provisional application No. 63/317,556, filed on Mar. 8, 2022.

(51) Int. Cl. H04L 41/0659; H04L 41/0654

(52) U.S. Cl. CPC H04L 41/0659; H04L 41/0672

(57) ABSTRACT

An access point that performs a remedial operation is described. This access point may include an interface circuit that communicates with a computer network device (such as a switch or a router) in a network that includes the access point and the computer network device. During operation, the access point may receive a packet or a frame associated with the computer network device. Then, based at least in part on information included in the packet or the frame, the access point may perform the remedial action, where the remedial action includes: updating a configuration of the access point, performing a factory reset and reboot of the access point, or both. For example, the factory reset may restore factory defaults of the access point. Alternatively or additionally, the information may include the address of the controller and/or a virtual local area network (VLAN) associated with the access point.

### CROSS REFERENCE TO RELATED APPLICATIONS

This application claims priority under 35 U.S.C. 119(e) to U.S. Provisional Application Ser. No. 63/317,556, “Zero-Touch Provisioning of an Access Point by a Switch,” filed on Mar. 8, 2022, by Saravanan Mohandass, et al. the contents of which are herein incorporated by reference.

### FIELD

The described embodiments relate to techniques for zero-touch provisioning of an access point by a computer network device (such as a switch or a router). Notably, the described embodiments relate to techniques for providing configuration information to the access point and/or performing a factory reset of the access point by a computer network device.

### BACKGROUND

Many electronic devices are capable of wirelessly communicating with other electronic devices. Notably, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Wash.), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

In typical enterprise Wi-Fi-based WLAN, the configuration and operation of an access point is typically managed by a controller. In order to latch an access point to a controller, the access point needs to be pre-provisioned with an address of the controller in a network or needs to obtain the address of the controller via an external server, e.g., by using a dynamic host control protocol. However, pre-provisioning is difficult in deployments with a large number of access points and obtaining the address of the controller from an external server is often not a seamless experience for a customer.

Alternatively, or additionally, sometimes an access point may malfunction or many no longer be reachable in the network (e.g., via an application at layer three or higher in an open systems interconnection or OSI model). When this occurs, a hard or hardware reset of the access point to restore factor defaults (which is sometimes referred to as a ‘factory reset’) may need to be performed. Usually, a factory reset requires physical access to the access point, e.g., in order to activate a reset button. However, physical access to the access point may be difficult with the access point is mounted in an elevated position, such as on the ceiling.

### SUMMARY

An access point that performs a remedial operation is described. This access point may include an interface circuit that communicates with a computer network device in a network that includes the access point and the computer network device. During operation, the access point receives a packet or a frame associated with the computer network device. Then, based at least in part on information included in the packet or the frame, the access point performs the remedial action, where the remedial action includes: updating a configuration of the access point, performing a factory reset and reboot of the access point, or both.

Note that the computer network device may include a switch or a router.

Moreover, the factory reset may restore factory defaults of the access point. The factory defaults may or may not include an address of a controller of the access point (such as an Internet protocol address) and/or may include second information specifying a virtual local area network (VLAN) associated with the access point (such as an identifier of the VLAN). For example, the VLAN may be a management VLAN of the access point. In some embodiments, after updating the configuration of the controller, e.g., in the management VLAN, the access point communicates with the controller.

Alternatively or additionally, the information from the computer network device may include the address of the controller and/or the second information specifying the VLAN.

Furthermore, the packet or the frame may be received using a wired communication protocol, such as a layer-two communication protocol. Additionally, the packet or the frame may be received on a port associated with a link between the access point and the computer network device.

For example, the wired communication protocol may include a link layer discovery protocol (LLDP). Note that the address of the controller and/or the second information specifying the VLAN may be included in link-level information with a vendor-specific attribute. Alternatively or additionally, the packet or frame may include an LLDP attribute (such as an LLDP-media endpoint discovery or LLDP-MED attribute) that specifies the factory reset and the reboot. In some embodiments, the LLDP attribute may include a vendor-specific attribute that specifies the factory reset and the reboot.

Another embodiment provides the computer network device that performs counterparts to at least some of the aforementioned operations. For example, the computer network device may determine that the access point is unavailable in the network, such as based at least in part on an error state of the access point, or an absence of an acknowledgment or communication with the access point. Then, the computer network device may automatically provide the packet or the frame addressed to the access point based at least in part on the determination. In some embodiments, the computer network device may provide a command line interface (CLI) or a user interface that allows the information in the packet or the frame to be specified. Alternatively or additionally, the computer network device may receive, via the CLI or the user interface, third information specifying the access point (such as an address of the access point in the network, such as a media access control or MAC address and a port address of the access point). In response, the computer network device may provide the packet or the frame addressed to the access point.

Another embodiment provides a computer-readable storage medium with program instructions for use with the access point or the computer network device. When executed by the access point or the computer network device, the program instructions cause the access point or the computer network device to perform at least some of the aforementioned operations in one or more of the preceding embodiments.

Another embodiment provides a method, which may be performed by the access point or the computer network device. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for performing a remedial action using an access point in FIG. 1 in accordance with an embodiment of the present disclosure.

FIG. 3 is a flow diagram illustrating an example of a method for providing a packet or a frame using a computer network device in FIG. 1 in accordance with an embodiment of the present disclosure.

FIG. 4 is a drawing illustrating an example of communication among a computer network device and an access point in FIG. 1 in accordance with an embodiment of the present disclosure.

FIG. 5 is a drawing illustrating an example of communication among a computer network device, an access point and a controller in FIG. 1 in accordance with an embodiment of the present disclosure.

FIG. 6 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An access point that performs a remedial operation is described. This access point may include an interface circuit that communicates with a computer network device (such as a switch or a router) in a network that includes the access point and the computer network device. During operation, the access point may receive a packet or a frame associated with the computer network device. Then, based at least in part on information included in the packet or the frame, the access point may perform the remedial action, where the remedial action includes: updating a configuration of the access point, performing a factory reset and reboot of the access point, or both. For example, the factory reset may restore factory defaults of the access point. Alternatively or additionally, the information may include the address of the controller. More generally, the information may include or may update an access-point configuration that facilitates communication with the controller. In some embodiments, after updating the configuration (which may update a management VLAN), the access point communicates with the controller.

Moreover, the computer network device may perform counterparts to at least some of the aforementioned operations. For example, the computer network device may determine that the access point is unavailable in the network, such as based at least in part on an error state of the access port, or an absence of an acknowledgment or communication with the access point. Then, the computer network device may automatically provide the packet or the frame addressed to the access point based at least in part on the determination. In some embodiments, the computer network device may provide a CLI or a user interface that allows the information in the packet or the frame to be specified (e.g., by a user of the computer network device). Alternatively or additionally, the computer network device may periodically provide the packet or frame even when the access point is available in the network. In some embodiments, the computer network device may receive, via the CLI or the user interface, additional information specifying the access point (such as an address of the access point in the network. In response, the computer network device may provide the packet or the frame addressed to the access point.

By facilitating updating of the configuration and/or the factory reset and the reboot, these communication techniques may allow the access point to be pre-provisioned with the configuration and/or to be recovered (such as when a hard or hardware reset is needed). Moreover, by allowing the configuration and/or the factory reset and the reboot to be initiated via communication between the access point and the computer network device, the communication techniques may facilitate updating a configuration of the access point and/or may eliminate a need for physical access to the access point. Consequently, the communication techniques may reduce the complexity and cost of pre-provisioning of the access point and/or performing the factory reset and the reboot. These capabilities may be useful in deployments with a large number of access points and/or when an access point is located at an elevated position, such as on the ceiling. Therefore, the communication techniques may improve the user experience when managing the access point and/or the network that includes the access point.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Tex.), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi and Ethernet are used as illustrative examples.

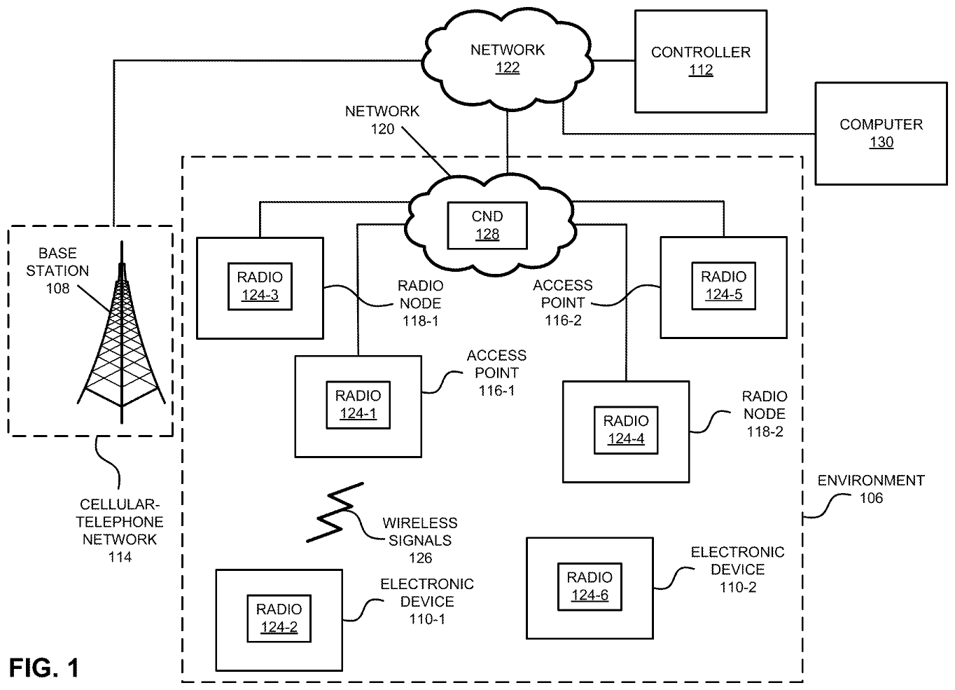

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or controller 112 (which may be a local or a cloud-based controller that manages and/or configures access points 116, radio nodes 118 and/or a computer network device (CND) 128 (which is sometimes referred to as a ‘peer network device’), or that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as computer network device 128).

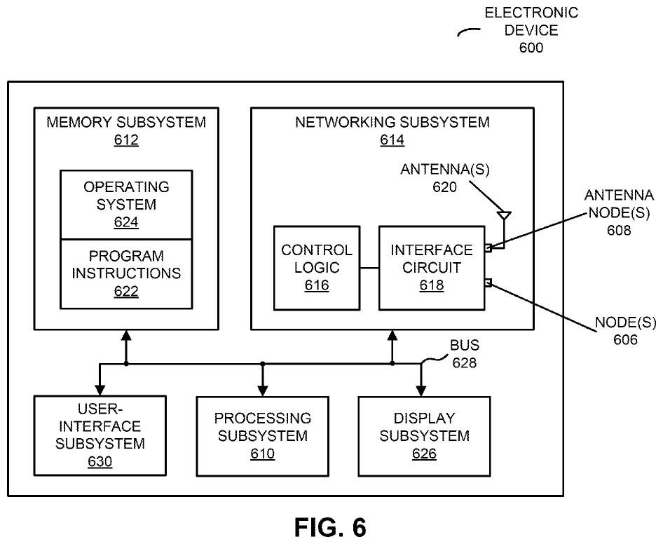

As described further below with reference to FIG. 6, electronic devices 110, controller 112, access points 116, radio nodes 118 and computer network device 128 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, it may be difficult to pre-provision an access point (such as access point 116-1) per the local network requirements, such as immediately following plug in or connection to a computer network device. Alternatively or additionally, it may be difficult to perform a factory reset and reboot of access point 116-1.

In order to address these problems, access point 116-1 may perform a remedial action based at least in part on communication with computer network device 128. Notably, controller 112 may instruct computer network device 128 to provide remedial-action information to access point 116-1. For example, the remedial-action information may include: an address of controller 112 (e.g., an Internet protocol address of controller 112); information specifying a VLAN associated with access point 116-1 (such as an identifier of the VLAN, which may be a management VLAN of access point 116-1); and/or information specifying a factory reset and/or reboot of access point 116-1. More generally, the remedial-action information may include additional and/or different information to configure access point 116-1, which may allow computer network device 128 to pre-provision access point 116-1. Alternatively or additionally, computer network device 128 may receive instructions for the remedial-action information via a CLI or a user interface, e.g., from a user of computer network device 128. For example, the user may remotely communicate with computer network device 128 using a computer 130 and network 120 and 122, and may provide: an address of access point 116-1 (such as a MAC address and/or a port address of access point 116-1), the address of controller 112 and/or the information specifying the VLAN. Note that the user interface may abstract the network topology, so that a user can use the user interface to select or specify access point 116-1, and based at least in part on this selection computer network device 128 may automatically fill in the address of access point 116-1. In some embodiments, computer network device 128 may automatically determine whether to provide the remedial-action information to access point 116-1, such as based at least in part on communication or an absence of communication associated with access point 116-1 (such as an error state of access point 116-1 and/or an absence of an acknowledgment or regular traffic from access point 116-1, which may indicate that access point 116-1 has malfunctioned or is unavailable).

Then, computer network device 128 may provide one or more packets or frames addressed to access point 116-1 with the remedial-action information. For example, the one or more packets or frames may be communicated from computer network device 128 to access point 116-1 using a wired communication protocol, such as a layer-two communication protocol. Additionally, the one or more packets or frames may be received on a port associated with a link between access point 116-1 and computer network device 128.

In some embodiments, the wired communication protocol may include an LLDP. Note that the address of controller 112 and/or the information specifying the VLAN may be included in link-level information with a vendor-specific attribute. Alternatively or additionally, the packet or frame may include an LLDP attribute (such as an LLDP-MED attribute) that specifies the factory reset and/or the reboot. In some embodiments, the LLDP attribute may include a vendor-specific attribute that specifies the factory reset and/or the reboot.

After receiving the one or more packets or frames, access point 116-1 may perform the remedial action. For example, access point 116-1 may update a configuration of access point 116-1, such as the address of controller 112 and/or the information specifying the VLAN. In some embodiments, after updating the configuration, access point 116-1 may communicate with controller 112.

Alternatively or additionally, after receiving the one or more packets or frames, access point 116-1 may perform the factory reset and/or the reboot. Note that the factory reset may restore factory or manufacturer defaults of access point 116-1, such as the address of controller 112, the information specifying the VLAN and/or more generally a configuration of access point 116-1.

In these ways, the communication techniques may facilitate an update of the configuration, the factory reset and/or the reboot. These capabilities may allow access point 116-1 to be pre-provisioned with the configuration (which may be specific to environment 106) and/or to be recovered (such as when a hard or hardware reset and/or a reboot are needed). Consequently, the communication techniques may reduce the complexity and cost of pre-provisioning of the access point and/or performing the factory reset and/or the reboot. Therefore, the communication techniques may improve the user experience when managing access point 116-1 and/or a network that includes access point 116-1.

While the preceding discussion illustrated the communication techniques with wired communication between computer network device 128 and access point 116-1, in some embodiments the communication techniques may be used to have another access point perform the remedial action based at least in part on wireless communication. For example, the other access point may be a mesh access point or an access point in a mesh network. In some embodiments, computer network device 128 may provide the packet or the frame intended for the other access point to access point 116-1, and then access point 116-1 provides the packet or frame to the other access point. In response, the other access point may perform the remedial action. Thus, in this way, computer network device 128 may facilitate an update to the configuration, a factory reset and/or a reboot of the other access point.

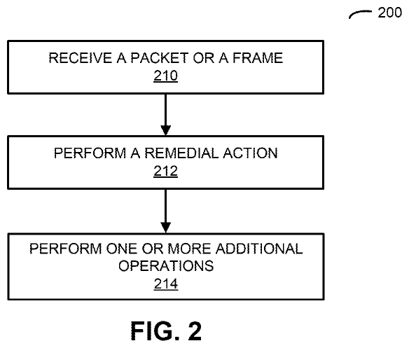

We now describe embodiments of the method. FIG. 2 presents a flow diagram illustrating an example of a method 200 for performing a remedial action, which may be performed by an access point (such as one of access points 116 or one of radio nodes 118 in FIG. 1). During operation, the access point may receive a packet or a frame (operation 210) associated with a computer network device (such as a switch or a router) in a network that includes the access point and the computer network device, where the packet or the frame includes information. Then, the access point may perform the remedial action (operation 212) based at least in part on the information, where the remedial action includes: updating a configuration of the access point, performing a factory reset, and/or performing a reboot of the access point.

Note that the factory reset may restore factory defaults of the access point. The factory defaults may or may not include an address of a controller of the access point (such as an Internet protocol address) and/or may include second information specifying a VLAN associated with the access point (such as an identifier of the VLAN). For example, the VLAN may be a management VLAN of the access point. Alternatively or additionally, the information may include the address of the controller and/or the second information specifying the VLAN.

Moreover, the packet or the frame may be received using a wired communication protocol, such as a layer-two communication protocol. Additionally, the packet or the frame may be received on a port associated with a link between the access point and the computer network device.

For example, the wired communication protocol may include an LLDP. Note that the address of the controller and/or the second information specifying the VLAN may be included in link-level information with a vendor-specific attribute. Alternatively or additionally, the packet or frame may include an LLDP attribute (such as an LLDP-MED attribute) that specifies the factory reset and the reboot. In some embodiments, the LLDP attribute may include a vendor-specific attribute that specifies the factory reset and the reboot.

In some embodiments, the access point may optionally perform one or more additional operations (operation 214). For example, after updating the configuration, the access point may communicate with the controller.

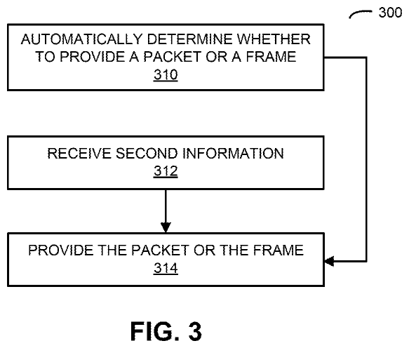

FIG. 3 presents a flow diagram illustrating an example of a method 300 for providing a packet or a frame, which may be performed by a computer network device (such as computer network device 128 in FIG. 1). During operation, the computer network device may automatically determine whether to provide the packet or the frame (operation 310) to an access point, which is included in the same network as the computer network device. For example, based on communication associated with the access point (such as an error state received from the access point and/or an absence of an acknowledgment or regular traffic associated with the access point, and more generally a change relative to an expected or historical traffic pattern or traffic statistic associated with the access point), the computer network device may determine whether to provide the packet or the frame to the access point. Note that the packet or the frame may include: information specifying an update to a configuration of the access point, information specifying or instructions for performing a factory reset, and/or information specifying or instructions for a reboot of the access point.

Alternatively, the computer network device may receive, associated with a controller or another computer, second information (operation 312) specifying or instructions for providing the packet or the frame to the access point. For example, the computer network device may support a CLI or may provide instructions for a user interface (such as to a computer of a user) that allows the information in the packet or the frame to be specified. Alternatively or additionally, the computer network device may receive, via the CLI or the user interface, third information specifying the access point (such as an address of the access point in the network, such as a MAC address and a port address of the access point).

Then, the computer network device may provide, addressed to the access point, the packet or the frame (operation 314), where the packet or the frame includes: the information specifying an update to a configuration of the access point, the information specifying or the instructions for performing a factory reset, and/or the information specifying or the instructions for a reboot of the access point.

In some embodiments of methods 200 (FIG. 2) and/or 300, there may be additional or fewer operations. Furthermore, the order of the operations may be changed, and/or two or more operations may be combined into a single operation.

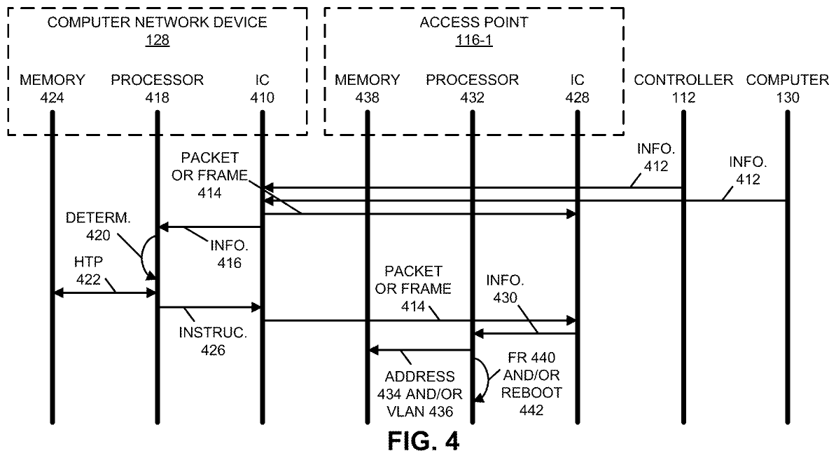

Embodiments of the communication techniques are further illustrated in FIG. 4, which presents a drawing illustrating an example of communication among computer network device 128 and access point 116-1, optionally controller 112 and/or optionally computer 130. In FIG. 4, an interface circuit (IC) 410 in computer network device 128 may receive, from controller 112, information 412 associated with access point 116-1. This information may include or may specify: an address of access point 116-1, an instruction to provide configuration information to access point 116-1, an instruction to provide or specify a factory-reset command to access point 116-1, and/or an instruction to provide or specify a reboot command to access point 116-1. Alternatively, interface circuit 410 may receive information 412 from computer 130, which is associated with a user of computer network device 128 (such as a network operator or administrator of a network that includes access point 116-1 and computer network device 128). Based at least in part on information 412, interface circuit 410 may provide a packet or a frame 414 to access point 116-1. This packet or frame may include or may specify: the address of access point 116-1, the instruction to provide configuration information to access point 116-1, the instruction to provide or specify the factory-reset command to access point 116-1, and/or the instruction to provide or specify the reboot command to access point 116-1.

In some embodiments, interface circuit 410 provides information 416 about communication (or an absence of communication) with access point 116-1 to a processor 418 in computer network device 128. Then, processor 418 may automatically determine 420 that an update to the configuration, the factory reset and/or the reboot of access point 116-1 is needed based at least in part on information 416. In some embodiments, processor 418 may make the determination 420 based at least in part on a historical traffic pattern (HTTP) 422 associated with access point 116-1, which may be stored in memory 424 in computer network device 128. For example, the historical traffic pattern 422 may include traffic statistics or one or more communication performance metrics associated with access point 116-1. By comparing current communication statistics associated with access point 116-1 (which may be specified by information 416) with the historical traffic pattern 422, processor 418 may determine whether or not access point 116-1 is available or offline (and, more generally, an operating status of access point 116-1), and thus whether or not to provide packet or frame 414. Based at least in part on the determination 420, processor 416 may instruct 426 interface circuit 410 to provide packet or frame 414 to access point 116-1.

(Alternatively or additionally, processor 418 may instruct 426 interface circuit 410 to periodically provide instances of packet or frame 414 to access point 116-1 independent of the availability or state of access point 116-1. Moreover, while FIG. 4 illustrates the intelligence or decision-making being performed by processor 418 in computer network device 128, in other embodiments the intelligence or decision-making is performed by controller 112, which may inform computer network device 128 when it determines that access point 116-1 is in an anomalous state, and which may then instruct computer network device 128 to provide packet or frame 414 to access point 116-1.)

After receiving packet or frame 414, interface circuit 428 in access point 116-1 may provide information 430 included in the packet or frame 414 to processor 432 in access point 116-1. Then, based at least in part on information 430, processor 432 may: update the configuration of access point 116-1 (e.g., by storing an address 434 of controller 112 and/or an identifier 436 of a VLAN associated with access point 116-1 in memory 438 in access point 116-1); perform a factory reset (FR) 440 of access point 116-1; and/or perform a reboot 442 of access point 116-1.

While FIG. 4 illustrates communication between components using unidirectional or bidirectional communication with lines having single arrows or double arrows, in general the communication in a given operation in this figure may involve unidirectional or bidirectional communication. Moreover, while FIG. 4 illustrates operations being performed sequentially or at different times, in other embodiments at least some of these operations may, at least in part, be performed concurrently or in parallel.

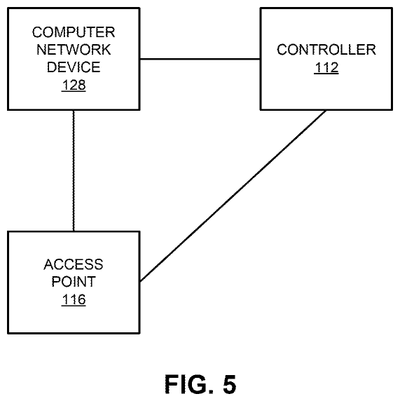

We now further describe the communication techniques. FIG. 5 presents a drawing illustrating an example of communication among computer network device 128, access point 116-1 and controller 122. Notably, controller 112 may manage access point 116-1 and computer network device 128. When needed (such as when a malfunction occurs in access point 116-1 and it is unable to communicate with controller 112), computer network device 128 may update a configuration of access point 116-1, e.g., computer network device 128 may provide an address of controller 112 (which is known by computer network device 128) to access point 116-1.

Alternatively or additionally, computer network device 128 may instruct or specify that access point 116-1 perform a factory reset and/or a reboot. More generally, a provisioning profile configuration may be exchanged between controller 112 and computer network device 128, and then computer network device 128 may provide the provisioning profile configuration to access point 116-1. For example, controller 112 may configure a port in computer network device 128 with an access-point profile. (Therefore, in some embodiments, the access-point profile may be implemented on a per-port basis by computer network device 128.) Then, when a new access point (such as access point 116-1) is latched to this port, an initial configuration may be pushed automatically from computer network device 128 to access point 116-1. This initial configuration may include an address of controller 112, and may allow access point 116-1 to communicate with controller 112 so that controller 112 can manage and/or configure access point 116-1. More generally, a given interface in computer network device 128 may be mapped to a specific profile that includes a ‘management VLAN’ along with an Internet protocol (IP) address of a controller of access point 116-1. Consequently, when an access point latches to the interface, it may obtain information that allows it to reach its controller without manual intervention.

In some embodiments, when access point 116-1 and computer network device 128 communicate using Ethernet via port 1/1/6 (and, more generally, a stack id/slot/port), a command on computer network device 128 to configure access point 116-1 may include ‘lldp med network-policy application access point tagged vlan <vlan id> controller-ip-address <ip addr> port ethernet 1/1/6.’ Alternatively or additionally, computer network device 128 may provide or support a CLI to reset access point 116-1 latched to this specific port, such as by providing ‘reset ap <ap-mac> ethernet 1/1/6’ to computer network device 128. In response, computer network device 128 may send one or more LLDP-MED values to access point 116-1 that specify the reset. For example, computer network device 128 may send the one or more LLDP-MED values in the next three transmit intervals (such as by transmitting the one or more LLDP-MED values three times that are each separated by two seconds) between computer network device 128 and access point 116-1. After receiving the LLDP-MED values, access point 116-1 may perform a factory reset and reboot, thereby allowing access point 116-1 to be recovered based at least in part on communication with a remote connected computer network device 128.

We now describe embodiments of an electronic device, which may perform at least some of the operations in the communication techniques. FIG. 6 presents a block diagram illustrating an example of an electronic device 600 in accordance with some embodiments, such as one of: base station 108, one of electronic devices 110, controller 112, one of access points 116, one of radio nodes 118, computer network device 128 or computer 130. This electronic device includes processing subsystem 610, memory subsystem 612, and networking subsystem 614. Processing subsystem 610 includes one or more devices configured to perform computational operations. For example, processing subsystem 610 can include one or more microprocessors, graphics processing units (GPUs), ASICs, microcontrollers, programmable-logic devices, and/or one or more digital signal processors (DSPs).

Memory subsystem 612 includes one or more devices for storing data and/or instructions for processing subsystem 610 and networking subsystem 614. For example, memory subsystem 612 can include DRAM, static random access memory (SRAM), and/or other types of memory. In some embodiments, instructions for processing subsystem 610 in memory subsystem 612 include: one or more program modules or sets of instructions (such as program instructions 622 or operating system 624, such as Linux, UNIX, Windows Server, or another customized and proprietary operating system), which may be executed by processing subsystem 610. Note that the one or more computer programs, program modules or instructions may constitute a computer-program mechanism. Moreover, instructions in the various modules in memory subsystem 612 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 610.

In addition, memory subsystem 612 can include mechanisms for controlling access to the memory. In some embodiments, memory subsystem 612 includes a memory hierarchy that comprises one or more caches coupled to a memory in electronic device 600. In some of these embodiments, one or more of the caches is located in processing subsystem 610.

In some embodiments, memory subsystem 612 is coupled to one or more high-capacity mass-storage devices (not shown). For example, memory subsystem 612 can be coupled to a magnetic or optical drive, a solid-state drive, or another type of mass-storage device. In these embodiments, memory subsystem 612 can be used by electronic device 600 as fast-access storage for often-used data, while the mass-storage device is used to store less frequently used data.

Networking subsystem 614 includes one or more devices configured to couple to and communicate on a wired and/or wireless network (i.e., to perform network operations), including: control logic 616, an interface circuit 618 and one or more antennas 620 (or antenna elements). (While FIG. 6 includes one or more antennas 620, in some embodiments electronic device 600 includes one or more nodes, such as antenna nodes 608, e.g., a metal pad or a connector, which can be coupled to the one or more antennas 620, or nodes 606, which can be coupled to a wired or optical connection or link. Thus, electronic device 600 may or may not include the one or more antennas 620. Note that the one or more nodes 606 and/or antenna nodes 608 may constitute input(s) to and/or output(s) from electronic device 600.) For example, networking subsystem 614 can include a Bluetooth™ networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 600 may be adapted or changed using pattern shapers (such as directors or reflectors) and/or one or more antennas 620 (or antenna elements), which can be independently and selectively electrically coupled to ground to steer the transmit antenna pattern in different directions. Thus, if one or more antennas 620 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 600 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 600 may use the mechanisms in networking subsystem 614 for performing simple wireless communication between the electronic devices, e.g., transmitting advertising or beacon frames and/or scanning for advertising frames transmitted by other electronic devices as described previously.

Within electronic device 600, processing subsystem 610, memory subsystem 612, and networking subsystem 614 are coupled together using bus 628. Bus 628 may include an electrical, optical, and/or electro-optical connection that the subsystems can use to communicate commands and data among one another. Although only one bus 628 is shown for clarity, different embodiments can include a different number or configuration of electrical, optical, and/or electro-optical connections among the subsystems.

In some embodiments, electronic device 600 includes a display subsystem 626 for displaying information on a display, which may include a display driver and the display, such as a liquid-crystal display, a multi-touch touchscreen, etc.

Moreover, electronic device 600 may include a user-interface subsystem 630, such as: a mouse, a keyboard, a trackpad, a stylus, a voice-recognition interface, and/or another human-machine interface. In some embodiments, user-interface subsystem 630 may include or may interact with a touch-sensitive display in display subsystem 626.

Electronic device 600 can be (or can be included in) any electronic device with at least one network interface. For example, electronic device 600 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 600, in alternative embodiments, different components and/or subsystems may be present in electronic device 600. For example, electronic device 600 may include one or more additional processing subsystems, memory subsystems, networking subsystems, and/or display subsystems. Additionally, one or more of the subsystems may not be present in electronic device 600. Moreover, in some embodiments, electronic device 600 may include one or more additional subsystems that are not shown in FIG. 6. Also, although separate subsystems are shown in FIG. 6, in some embodiments some or all of a given subsystem or component can be integrated into one or more of the other subsystems or component(s) in electronic device 600. For example, in some embodiments instructions 622 is included in operating system 624 and/or control logic 616 is included in interface circuit 618.

Moreover, the circuits and components in electronic device 600 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 614 and/or of electronic device 600. The integrated circuit may include hardware and/or software mechanisms that are used for transmitting wireless signals from electronic device 600 and receiving signals at electronic device 600 from other electronic devices. Aside from the mechanisms herein described, radios are generally known in the art and hence are not described in detail. In general, networking subsystem 614 and/or the integrated circuit can include any number of radios. Note that the radios in multiple-radio embodiments function in a similar way to the described single-radio embodiments.

In some embodiments, networking subsystem 614 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 622, operating system 624 (such as a driver for interface circuit 618) or in firmware in interface circuit 618. Alternatively or additionally, at least some of the operations in the communication techniques may be implemented in a physical layer, such as hardware in interface circuit 618.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An access point, comprising:
an interface circuit configured to communicate with a computer network device in a network comprising the access point and the computer network device, wherein the access point is configured to perform operations comprising:
receiving a packet or a frame associated with the computer network device, wherein the packet or the frame comprises information; and
based at least in part on the information, performing a remedial action, wherein the remedial action comprises: updating a configuration of the access point, performing a factory reset and reboot of the access point, or both.

2. The access point of claim 1, wherein the computer network device comprises a switch or a router.

3. The access point of claim 1, wherein the factory reset restores factory defaults of the access point.

4. The access point of claim 1, wherein the information comprises an address of a controller of the access point, second information specifying a virtual local area network (VLAN) associated with the access point, or both.

5. The access point of claim 1, wherein, after updating the configuration, the operations comprise communicating with the controller.

6. The access point of claim 1, wherein the information comprises: an address of the controller of the access point, second information specifying a virtual local area network (VLAN) associated with the access point, or both.

7. The access point of claim 1, wherein the packet or the frame is received on a port associated with a link between the access point and the computer network device.

8. The access point of claim 1, wherein the packet or the frame is received using a wired communication protocol.

9. The access point of claim 8, wherein the wired communication protocol comprises a layer-two communication protocol.

10. The access point of claim 8, wherein the wired communication protocol comprises a link layer discovery protocol (LLDP).

11. The access point of claim 10, wherein an address of a controller of the access point, second information specifying a virtual local area network (VLAN) associated with the access point, or both is including in link-level information with a vendor-specific attribute.

12. The access point of claim 10, wherein the packet or frame comprises an LLDP attribute that specifies the factory reset and the reboot.

13. The access point of claim 12, wherein the LLDP attribute comprises a vendor-specific attribute that specifies the factory reset and the reboot.

14. A non-transitory computer-readable storage medium for use in conjunction with an access point, the computer-readable storage medium storing program instructions that, when executed by the access point, cause the access point to perform operations comprising:
receiving a packet or a frame associated with a computer network device in a network comprising the access point and the computer network device, wherein the packet or the frame comprises information; and
based at least in part on the information, performing a remedial action, wherein the remedial action comprises: updating a configuration of the access point, performing a factory reset and reboot of the access point, or both.

15. The non-transitory computer-readable storage medium of claim 14, wherein the factory reset restores factory defaults of the access point.

16. The non-transitory computer-readable storage medium of claim 14, wherein the information comprises: an address of the controller of the access point, second information specifying a virtual local area network (VLAN) associated with the access point, or both.

17. A method for performing a remedial action, comprising:
by an access point:
receiving a packet or a frame associated with a computer network device in a network comprising the access point and the computer network device, wherein the packet or the frame comprises information; and
based at least in part on the information, performing the remedial action, wherein the remedial action comprises: updating a configuration of the access point, performing a factory reset and reboot of the access point, or both.

18. The method of claim 17, wherein the factory reset restores factory defaults of the access point.

19. The method of claim 17, wherein the information comprises: an address of the controller of the access point, second information specifying a virtual local area network (VLAN) associated with the access point, or both.

20. The method of claim 17, wherein the packet or the frame is received using a wired communication protocol; and
wherein the wired communication protocol comprises a layer-two communication protocol.
